(19) United States
(12) Patent Application Publication
(10) Pub. No.: US 2010/0198824 A1
(43) Pub. Date: Aug. 5, 2010

(54) IMAGE KEYWORD APPENDING APPARATUS, IMAGE SEARCH APPARATUS AND METHODS OF CONTROLLING SAME

(75) Inventor: Hisayoshi TSUBAKI, Ashigarakami-gun (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 12/694,749

(22) Filed: Jan. 27, 2010

(30) Foreign Application Priority Data
Jan. 30, 2009 (JP) 2009-019515

(51) Int. Cl. G06F 7/10; G06F 17/30

(52) U.S. Cl. 707/736; 707/769; 707/E17.019; 707/E17.03

(57) ABSTRACT

A keyword or the like effective for conducting a search is appended to an image. Subjects contained in an image are detected. The subject names and positions of the respective subjects that have been detected are detected. Keywords representing broader concepts of the detected subject names and the positions of the subjects are stored in correlation with the image as data to be used in searching for the image. If a search for the image is conducted, the subject names or broader concepts of the subject names, which serve as keywords, and the positions of the subjects are input. An image that matches the entered subject names, etc., and subject positions is retrieved. Rather than retrieving an image simply using keywords alone, an image is retrieved utilizing also the positions of subjects. As a result, it is possible to narrow down images found in a case where a desired image is to be retrieved from among a large number of images.

### BACKGROUND OF THE INVENTION

1. Field of the Invention

This invention relates to an image keyword appending apparatus, an image search apparatus and methods of controlling same.

2. Description of the Related Art

When a photo of subject is shot using a digital still camera, information such as the shooting date is appended to the image data obtained by such image capture. When images are searched, it is convenient if a keyword has been appended in addition to information such as the shooting date. Hence there are instances where a keyword is appended to an image. If the images are large in number, however appending a keyword to every image is a troublesome task.

For this reason, there is a technique for alleviating the keyword appending operation (see Japanese Patent Application Laid-Open No. 2007-207031). Further, there is a technique for detecting persons in an image and appending keywords in accordance with the number of persons who are subjects (see Japanese Patent Application Laid-Open No. 2006-350552). In a case where there are no persons in an image, however, keywords all become the same and a keyword conforming to number of persons who are subjects is not satisfactory as a keyword. Furthermore, there is a technique for appending a keyword that is related to the result of subject recognition (see Japanese Patent Application Laid-Open No. 2007-304771). However, in a case such as one where a photo of a family has been shot, keywords often become the same. There is also a technique using image recognition (see Japanese Patent Application Laid-Open No. 2001-330882).

### SUMMARY OF THE INVENTION

Accordingly, an object of the present invention is to append a keyword that is effective for conducting a search.

An image keyword appending apparatus according to a first aspect of the present invention comprises: a keyword-target image data input device for inputting keyword-target image data for appending a keyword; a first detecting device for detecting a predetermined subject and position of this subject from a keyword-target image represented by the keyword-target image data that has been input from the keyword-target image data input device; and a storage control device for storing data representing name of the subject and data representing the position of the subject, which has been detected by the first detecting device, on a storage medium in correlation with the keyword-target image data as data used in searching for the keyword-target image.

The first aspect of the present invention also provides an operation control method suited to the above-described image keyword appending apparatus. Specifically, the method comprises the steps of: inputting keyword-target image data for appending a keyword; detecting a predetermined subject and position of this subject from a keyword-target image represented by the keyword-target image data that has been input; and storing data representing name of the detected subject and data representing the position of the detected subject on a storage medium in correlation with the keyword-target image data as data used in searching for the keyword-target image.

In accordance with the present invention, when keyword-target image data is input, a predetermined subject and position of this subject are detected from a keyword-target image represented by the keyword-target image data that has been input. The name of the detected subject and the position of the subject are correlated with the keyword-target image as keywords. In accordance with the first aspect of the present invention, the name and position of a subject are appended to keyword-target image data as data used in a search. As a result, a desired image can be found utilizing the name and position. A keyword (search condition) effective for conducting a search can thus be appended to the keyword-target image.

The apparatus may further comprise a second detecting device for detecting the size of the subject, which has been detected by the first detecting device, in the keyword-target image. In this case, in addition to the data representing the name of the subject and the data representing the position of the subject, which has been detected by the first detecting device, the storage control device stores data representing the size detected by the second detecting device on the storage medium in correlation with the keyword-target image data as data used in searching for the keyword-target image.

The position of a subject detected by the first detecting device is, for example, the position of an area in which the subject is present in a case where the keyword-target image has been divided into a plurality of areas.

The position of a subject detected by the first detecting device may be a position decided by an overall ratio, vertically and horizontally, with respect to the keyword-target image.

The apparatus may further comprise a third detecting device for detecting the name of a broader concept of the subject detected by the first detecting device. In this case, in addition to the data representing the name of the subject and the data representing the position of the subject, which has been detected by the first detecting device, the storage control device stores data representing the name of the broader concept detected by the third detecting device on the storage medium in correlation with the keyword-target image data as data used in searching the keyword-target image.

An image search apparatus according to a second aspect of the present invention comprises: a keyword input device for inputting a keyword; a position input device for inputting position of a subject corresponding to the keyword that has been input by the keyword input device; and a search device for finding an image from among a number of images, wherein the image includes a subject corresponding to at least one of the keyword that has been input from the keyword input device and a broader concept of this keyword, or to at least one of the keyword that has been input from the keyword input device and a more limitative concept of this keyword, the subject being present at the position that has been input from the position input device.

The second aspect of the present invention also provides an operation control method suited to the above-described image search apparatus. Specifically, the method comprises the steps of: inputting a keyword; inputting position of a subject corresponding to the keyword that has been input; and finding an image from among a number of images, wherein the image includes a subject corresponding to at least one of the keyword that has been input and a broader concept of this keyword, or to at least one of the keyword that has been input and a more limitative concept of this keyword, the subject being present at the position that has been input.

In accordance with the second aspect of the present invention, a keyword and the position of a subject corresponding to the keyword are input. Found from among a number of images are an image that includes a subject corresponding to at least one of the input keyword and a broader concept of this keyword, or to at least one of the keyword and a more limitative concept of this keyword, wherein the subject is present at the position that has been input. Not only is an image that includes a subject corresponding to at least one of the input keyword and a broader concept of this keyword found, but the image in which this subject is present at the input position is found. This means that an image desired by the user can be found more appropriately.

The apparatus may further comprise a size designating device for designating the size of a subject, which corresponds to a keyword that has been input from the keyword input device, in an image. In this case, the search device would find an image from among a number of images, wherein the image includes a subject corresponding to the keyword that has been input from the keyword input device, the subject being present at the position that has been input from the position input device and having the size designated by the size designating device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 illustrates an example of an image search apparatus;

FIG. 2 illustrates an example of a subject feature table;

FIG. 3 illustrates an example of a broader-concept table;

FIG. 4 illustrates an example of an image;

FIG. 5 is a flowchart illustrating keyword appending processing;

FIG. 6 illustrates an example of a feature table of an image 1;

FIG. 7 illustrates an image that has been divided into a plurality of areas;

FIGS. 8 and 9 are examples of feature tables of image 1;

FIGS. 10 to 14 are examples of images;

FIG. 15 illustrates an example of a feature table;

FIG. 16 is a flowchart illustrating image search processing; and

FIGS. 17 to 20 are examples of search windows.

### DESCRIPTION OF THE PREFERRED EMBODIMENTS

Preferred embodiments of the present invention will now be described in detail with reference to the accompanying drawings.

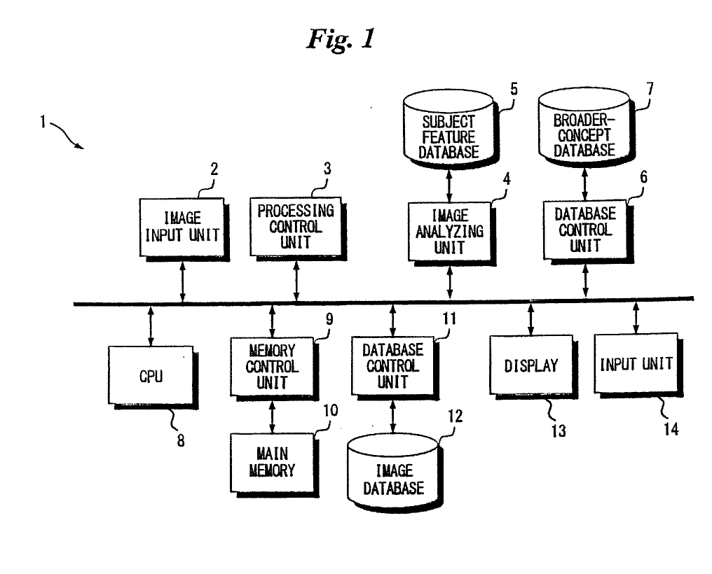

FIG. 1 is a block diagram illustrating the electrical configuration of an image search apparatus (image keyword appending apparatus) 1 according to a preferred embodiment of the present invention.

The overall operation of the image search apparatus 1 is controlled by a CPU 8. The image search apparatus 1 includes a main memory 10 storing a control program and other data, etc. The main memory 10 is controlled by a memory control unit 9.

Image data representing an image that is the object of a search is input from an image input unit 2. The input image data is stored in an image database 12 under the control of a database control unit 11.

The image search apparatus 1 includes a subject feature database 5. The subject feature database 5 stores the features of subjects included in images together with the names (subject names) of these subjects. The subject feature database 5 is controlled by a processing control unit 3 and an image analyzing unit 4.

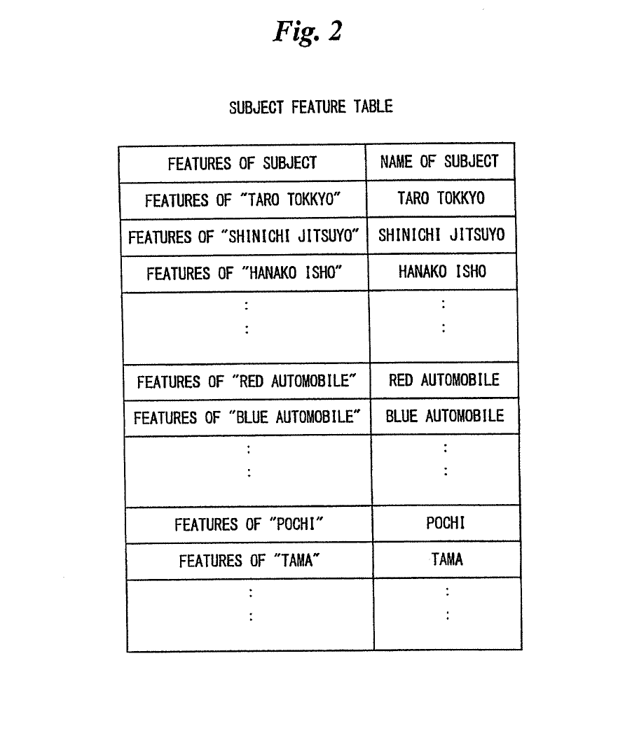

FIG. 2 is an example of a subject feature table that has been stored in the subject feature database 5.

As mentioned above, the subject feature table is such that data representing the features of subjects have been stored in correspondence with the names of the subjects. The features of a subject constitute information for detecting (extracting) this subject from within an image. For example, if a subject is “Taro Tokkyo”, then information to the effect that the subject is to be considered as “Taro Tokkyo”, the relative positions of the eyes, nose and mouth of the face, and information indicating size, hair color and length constitute are features of “Taro Tokkyo”. If a subject included in an image has the features of “Taro Tokkyo”, then the name of this subject is decided upon as “Taro Tokkyo”. Further, if a subject is “red automobile”, then information indicating the shape and color (red) of the automobile is the feature of “Red Automobile”. If a subject included in an image has the features of “Red Automobile”, then the name of this subject is decided upon as “Red Automobile”.

With reference again to FIG. 1, the image search apparatus 1 includes also a broader-concept database 7. Keywords that represent a broader concept of the name of a subject have been stored in the broader-concept database 7 in correspondence with the name of the subject. The broader-concept database 7 is controlled by a database control unit 6.

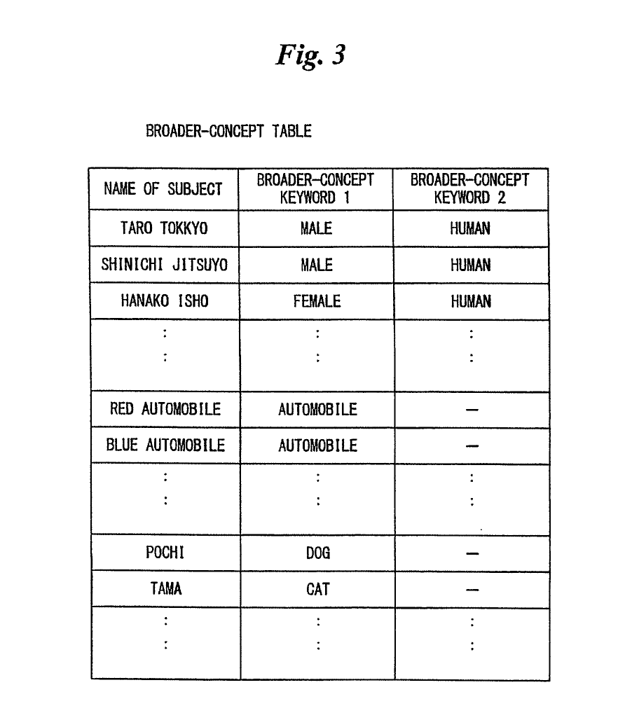

FIG. 3 is an example of a broader-concept table stored in the broader-concept database 7.

As mentioned above, a first keyword (broader-concept keyword 1) representing a broader concept of the name of a subject and a second keyword (broader-concept keyword 2) representing a concept broader than that of the first keyword have been stored in the broader-concept table in correspondence with the name of the subject. For example, in a case where the name of the subject is “Taro Tokkyo”, the broader-concept keyword 1 is “Male” and the broader-concept keyword 2 is “Human”. In a case where the name of the subject is “Red Automobile”, the broader-concept keyword 1 is “Automobile” but the broader-concept keyword 2 has not been set. It goes without saying that a broader concept such as “Vehicle” may just as well be set as the broader-concept keyword 2. The above holds true for the other subject names as well.

With reference again to FIG. 1, the content of the subject feature that has been stored in the subject feature database 5 and the content of the broader-concept table that has been stored in the broader-concept database 7 are set by the user (operator) in advance.

The image search apparatus 1 is provided with a display unit 13 and input unit 14 for inputting keywords, etc., when an image is searched.

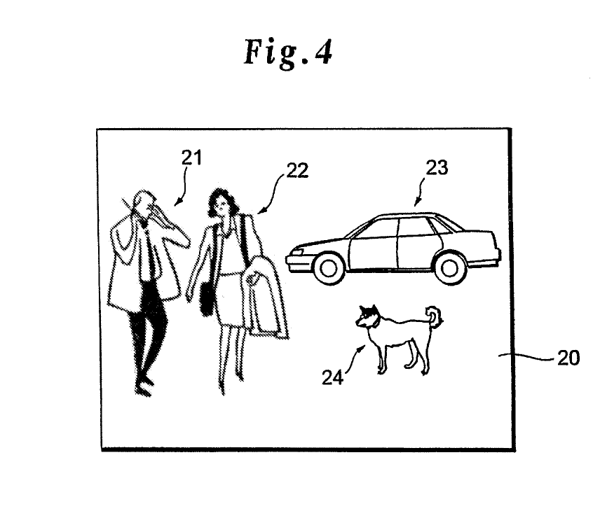

FIG. 4 is an example of an image 20.

A subject 21 having the subject name “Taro Tokkyo” is present on the left side of the image 20. A subject 22 having the subject name “Hanako Isho” is present just to the right of the subject 21. Further, a subject 23 having the subject name “Red Automobile” is present at the upper right of the image 20. A subject 24 having the subject name “Pochi” is present below the subject 23.

Assume that a keyword, etc. (data to be used in a search) will be appended to this image 20 (an image to which a keyword is to be appended, referred to simply as the “keyword-target image” below).

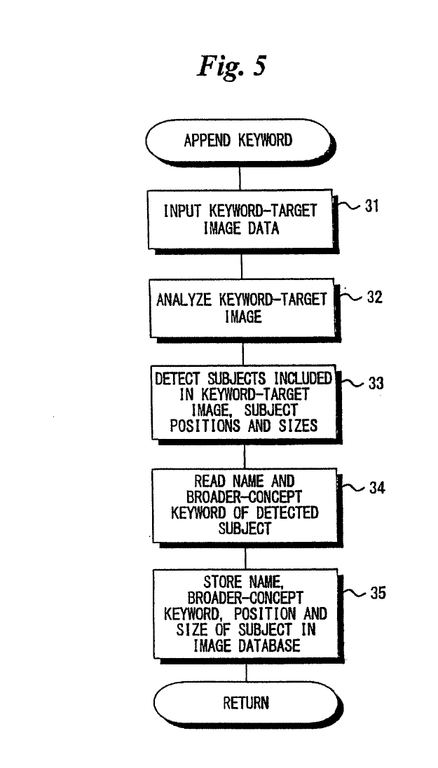

FIG. 5 is a flowchart illustrating processing for appending a keyword.

Image data (keyword-target image data) representing the keyword-target image 20 to which a keyword is to be appended is read from the image database 12 and input to the image analyzing unit 4 (step 31). In a case where keyword-target image data has not been stored in the image database 12, the data is input from the image input unit 2 to the image search apparatus 1 and is applied to the image analyzing unit 4.

All subjects included in the keyword-target image 20, the positions of these subjects and the sizes thereof are detected in the image analyzing unit 4 (step 33). When a subject is detected, the subject name of the subject is detected using the subject feature table (see FIG. 2) based upon the features of this subject. When the subject name is detected, the broader-concept keyword of this subject name is read using the broader-concept table (see FIG. 3) (step 34).

The subject name, broader-concept keyword and position and size of the subject are stored in the image database 12 (step 35).

Detection of subject names and reading of broader concepts are carried out with regard to all subjects included in the keyword-target image 20.

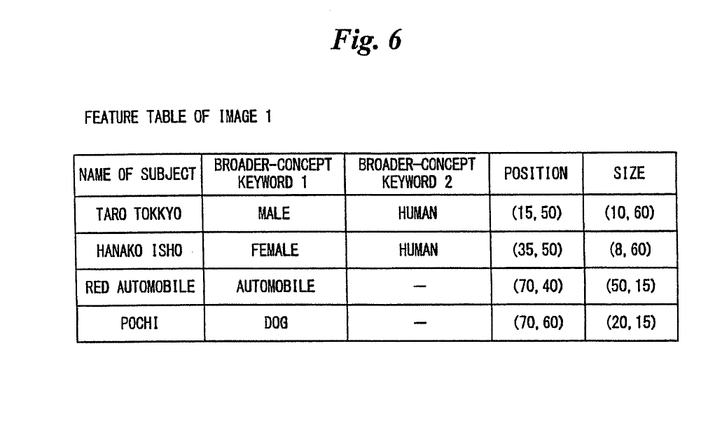

FIG. 6 is an example of the feature table stored in the image database 12. The feature table regards the keyword-target image 20. If keyword appending processing is executed with regard to another image, then a feature table corresponding to this image will be stored in the image database 12.

The broader-concept keyword 1, broader-concept keyword 2, position of the subject and size of the subject (data used in conducting a search) have been stored in the feature table in correspondence with the name of the subject. If the upper left of the keyword-target image 20 is considered the origin, then the position of the subject indicates the coordinate position of the center (centroid) of the subject. If a rectangle inscribing or circumscribing the subject is considered, the position of the subject will be the center of the rectangle. In a case where the size of the keyword-target image horizontally is 100 and the size thereof vertically is 100, the size of the subject will be represented by a set of the size of the subject horizontally with respect to the size of the keyword-target image horizontally and the size of the subject vertically with respect to the size of the keyword-target image vertically.

Thus, the name of a subject included in the keyword-target image 20 and the keyword, position and size of this subject can be appended to the keyword-target image 20.

In the embodiment described above, the position of a subject is a coordinate position in the keyword-target image 20. However, in a case where the keyword-target image 20 has been divided into a plurality of areas, the position of the subject may be one which indicates in which area the image of the subject is present rather than a coordinate position.

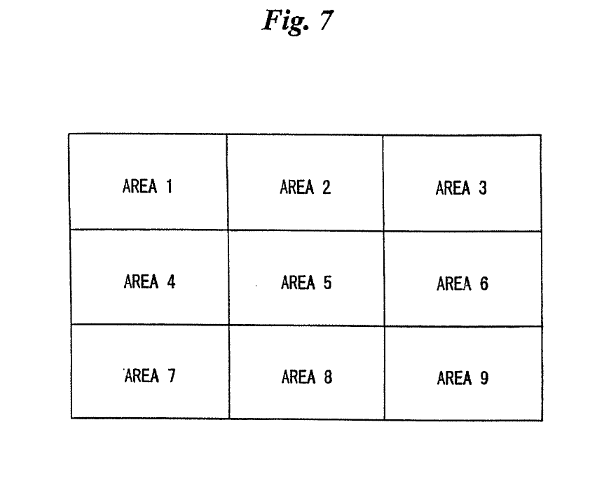

FIG. 7 illustrates an example in which an image has been divided.

The image has been divided into three areas horizontally and three areas vertically, that is, into nine areas denoted by areas 1 to 9. In which of these nine areas a subject exists can be stored in the feature table as the position of the subject.

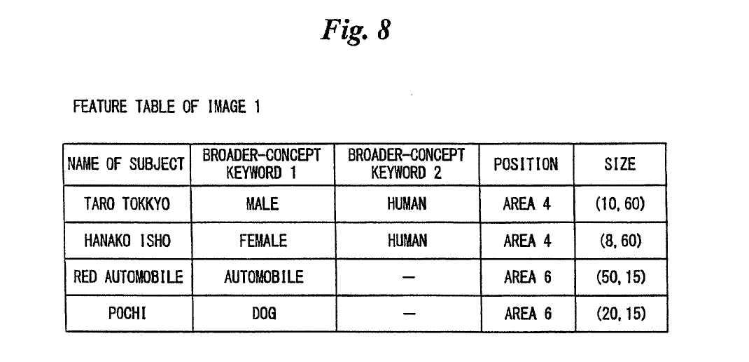

FIG. 8 is an example of a feature table in which areas rather than coordinate positions have been stored as subject positions.

It is assumed that the subject 21 having the subject name “Taro Tokkyo” is present in the area 4. Similarly, it is assumed that the subject 22 having the subject name “Hanako Isho” also is present in the area 4 and that the subject 23 having the subject name “Red Automobile” and the subject 24 having the subject name

“Pochi” both are present in the area 6.

Areas such as an area in which the center position of a subject is present and an area that contains many subjects can be decided upon as areas in which these subjects are present.

Furthermore, a relative ratio with respect to the keyword-target image 20 can be adopted as the position of a subject.

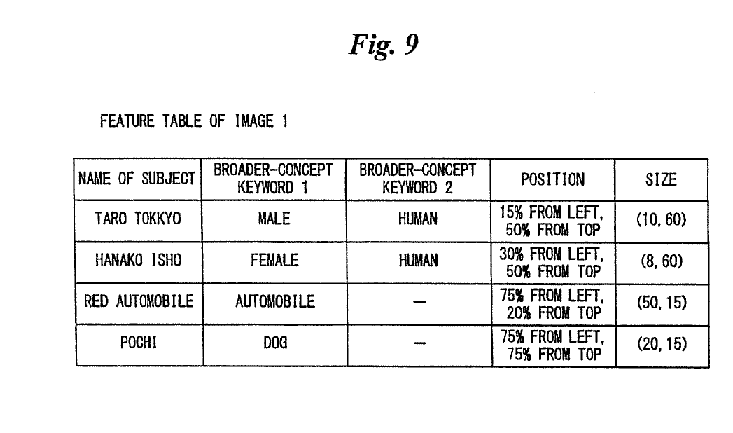

FIG. 9 is an example of a feature table in a case where a relative ratio with respect to the keyword-target image 20 is adopted as the position of a subject.

It is assumed here that the subject 21 having the subject name “Taro Tokkyo” is present in an area that is 15% from the left and 50% from the top. Similarly, the subject 22 having the subject name “Hanako Isho” is present in an area that is 30% from the left and 50% from the top, the subject 23 having the subject name “Red Automobile” is present in an area that is 75% from the left and 20% from the top, and the subject 24 having the subject name “Pochi” is present in an area that is 75% from the left and 75% from the top.

Thus, a relative positional ratio with respect to the keyword-target image 20 can be adopted as the position of a subject.

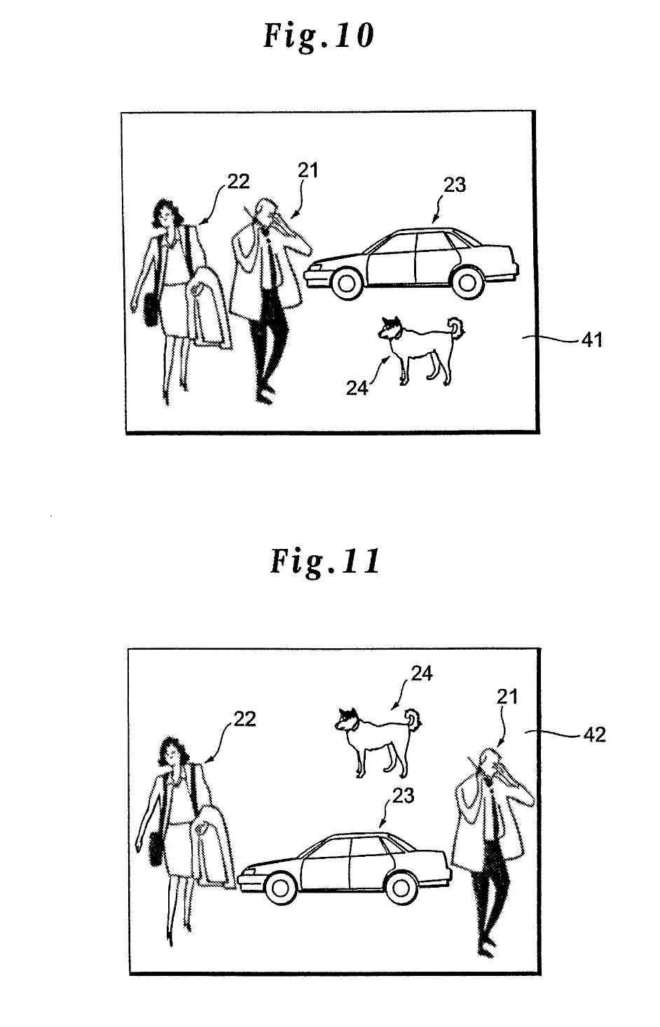

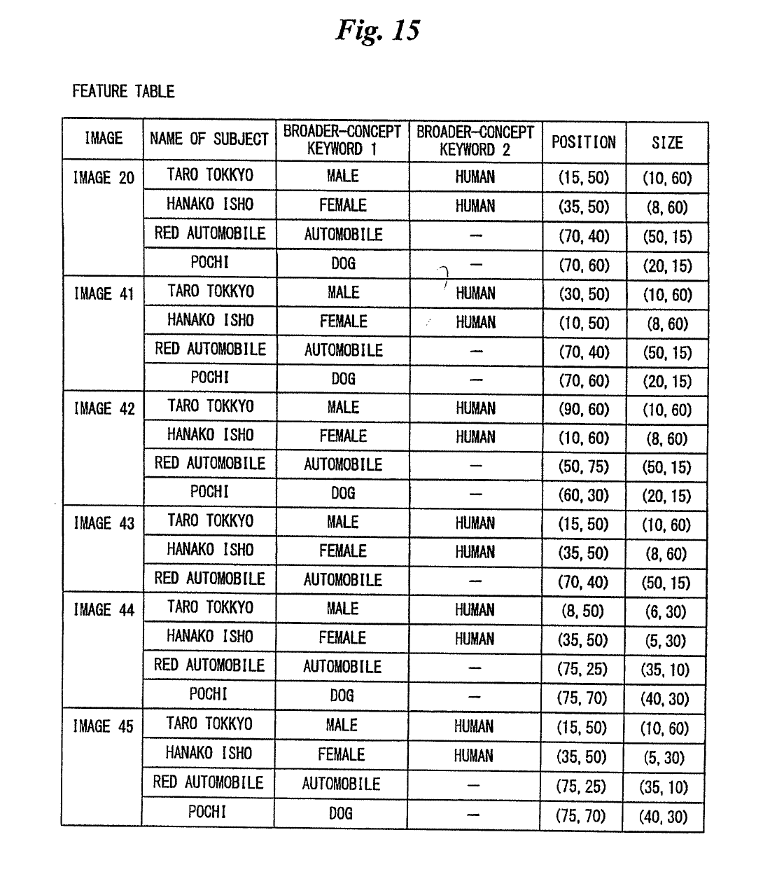

FIGS. 10 to 14 illustrate examples of other images. FIG. 15 is an example of a feature table regarding the image shown in FIG. 4 and the images shown in FIGS. 10 to 14.

An image 41 shown in FIG. 10 is the result of interchanging the placement of the subjects 21 and 22 of image 20 shown in FIG. 4. In the image 41 shown in FIG. 10, the subject 22 having the subject name “Hanako Isho” is on the left side of the image 41 and the subject 21 having the subject name “Taro Tokkyo” is to the right of the subject 22. The subject 23 having the subject name “Red Automobile” is at the top right of the image 41, and the subject 24 having the subject name “Pochi” is below the subject 23.

As illustrated in FIG. 15, it will be understood that although the subject names, broader-concept keywords 1, broader-concept keywords 2 and sizes of the subjects in the image 41 stored in the feature table are the same as those regarding the image 20, the positions of the subjects 21 and 22 have changed.

In an image 42 shown in FIG. 11, the subject 22 having the subject name “Hanako Isho” is on the left side of the image 42 and the subject 23 having the subject name “Red Automobile” is to the right of the subject 22. The subject 24 having the subject name “Pochi” is above the subject 23, and the subject 21 having the subject name “Taro Tokkyo” is to the right of the subject 23.

As illustrated in FIG. 15, although the subject names, broader-concept keywords 1, broader-concept keywords 2 and sizes of the subjects in the image 42 stored in the feature table are the same as those regarding the image 20 or the image 41, the positions of the subjects 21 to 24 have changed.

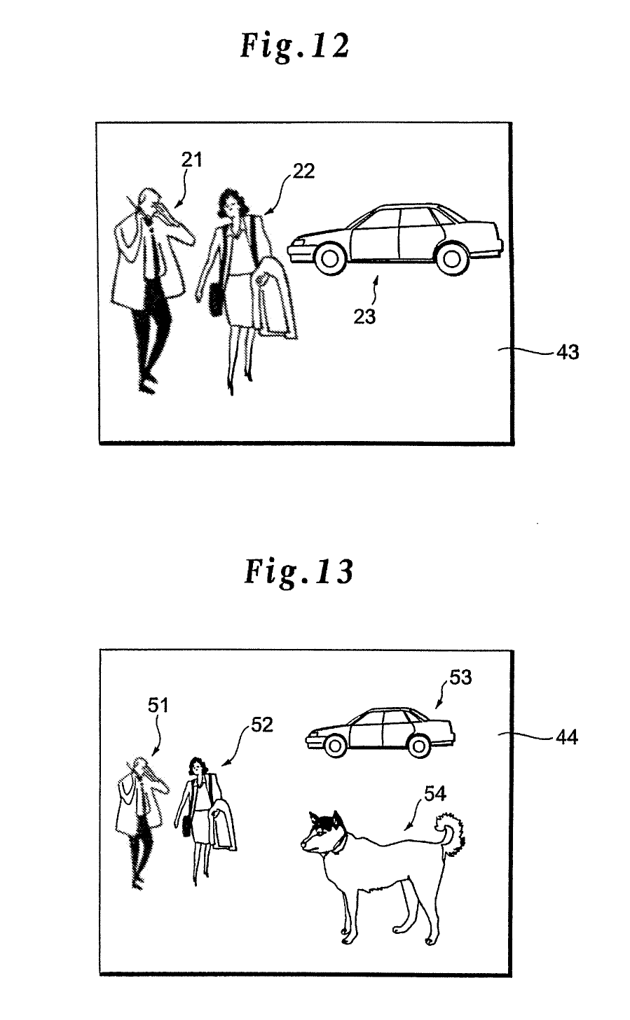

In an image 43 shown in FIG. 12, the positional relationship and sizes of the subjects 21 to 23 are the same as the positional relationship and sizes of the subjects 21 to 23 in the image 20, but the subject 24 having the subject name “Pochi” does not exist. Information regarding the subject 24 having the subject name “Pochi”, therefore, has not been stored in the feature table shown in FIG. 15.

Image 44 shown in FIG. 13 contains subjects 51 to 54 identical with the subjects 21 to 24 contained in the image 41 shown in FIG. 10 and in the image 42 shown in FIG. 11. Subject 51 having the subject name “Taro Tokkyo” corresponds to the subject 21, subject 52 having the subject name “Hanako Isho” corresponds to the subject 22, subject 53 having the subject name “Red Automobile” corresponds to the subject 23, and subject 54 having the subject name “Pochi” corresponds to the subject 24. The sizes of the respective subjects 51, 52 and 54 are large in comparison with the sizes of the respective subjects 21, 22 and 24. The size of the subject 53 is small in comparison with the subject 23. The sizes that have been stored in the feature table shown in FIG. 15, therefore, are larger or smaller than the sizes of the subjects in image 20, etc., shown in FIG. 4, etc.

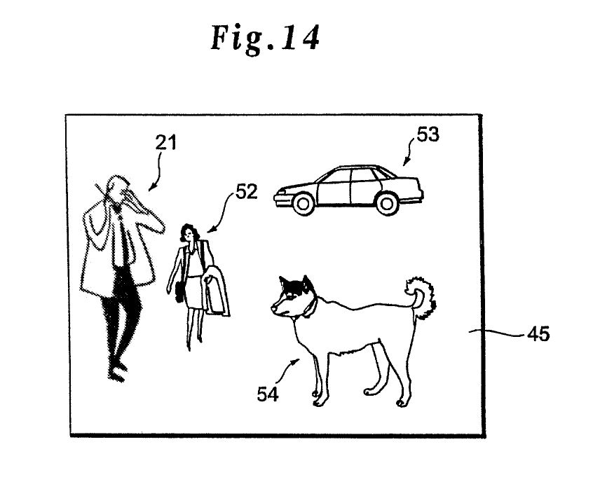

Image 45 shown in FIG. 14 contains the subject 21 and the subjects 52 to 54. Although the positional relationship of these subjects 21 and 52 to 54 is the same as the positional relationship of the subjects 21 to 24 included in the image 20 shown in FIG. 4, the sizes of the subjects 52 and 53 are smaller than the sizes of the subjects 22 and 23 in the image 20 shown in FIG. 4, and the size of the subject 54 is larger than the size of the subject 20 shown in FIG. 4. The sizes that have been stored in the feature table shown in FIG. 15, therefore, also are larger or smaller than the sizes of the subjects in image 20, etc., shown in FIG. 4, etc.

The feature table shown in FIG. 6 is generated for every image. However, it may be so arranged that the data regarding all images is stored in a single feature table as in the manner of the feature table shown in FIG. 15.

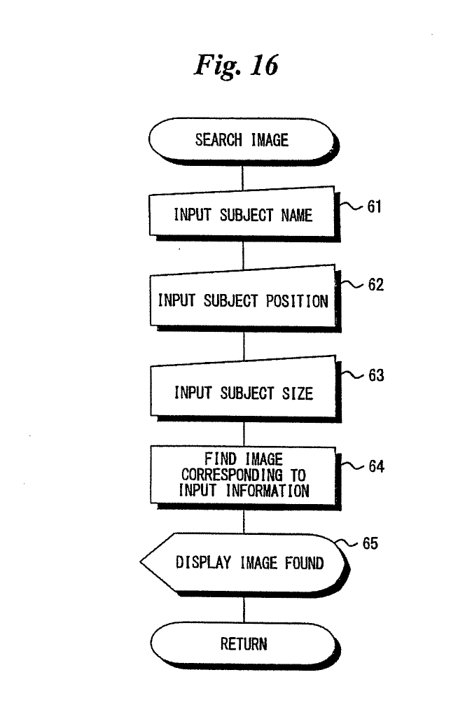

FIGS. 16 to 20 illustrate another embodiment and relate to the finding of an image by means of a search.

FIG. 16 is a flowchart illustrating image search processing.

First, the subject name of a subject contained in an image desired to be found, the position of this subject and the size thereof are input from the input unit 14 (steps 61 to 63). An image having the subject name, subject position and subject size that have been input is found among a number of images that have been stored in the image database 12 (step 64). The image found is displayed on the display screen of the display unit 13 (step 65).

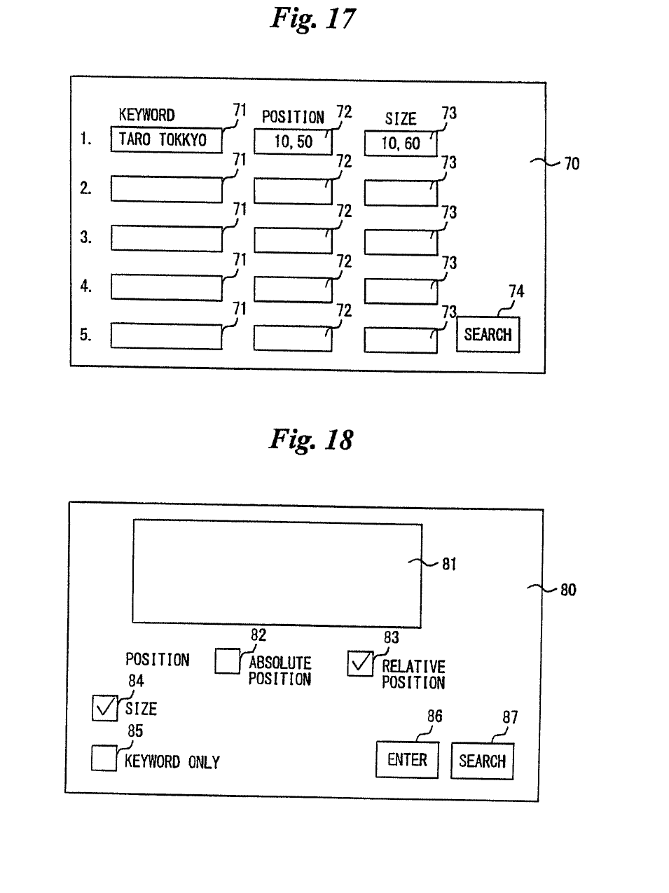

FIG. 17 is an example of a search window 70 displayed on the display screen of the display unit 13.

A keyword display area 71, subject-position display area 72 and subject-size display area 73 are arranged in a single row as a single set in the search window 70. Five such sets are arrayed vertically in the search window 70. Further, a search command button 74 is formed at the lower right of the search window 70.

If any area among the keyword display area 71, subject-position display area 72 and subject-size display area 73 is selected, an input can be made in the selected area. The information input is displayed in the selected area. (It goes without saying that the input unit 14 includes a mouse and that the desired area can be selected by utilizing the mouse.

Naturally, if a touch-sensitive panel has been formed on the display screen of the display unit 13, then the desired area can be selected by touching the desired display area.)

A subject name or a broader concept of this product name is input as a keyword in the keyword display area 71. As for position, the coordinate position in the subject is being displayed. However, the position need not necessarily be the coordinate position. It may be so arranged that what is input is the desired area in a case where the image has been divided into a plurality of areas, or the ratio with respect to the image, as illustrated in FIG. 8 or 9.

By inputting information in at least one area among the areas 71 to 73 and clicking (touching) the search command button 74, the image corresponding to the input information is searched and the desired image is retrieved.

Although it may be arranged to find an image containing a subject whose position and size match completely the input information, it is preferred that an arrangement be adopted in which an image containing a subject that is close to the input information is found.

Thus, an image is found which contains a subject possessing a subject name having a keyword, which has been input to the keyword display area 71, as a subject name or broader-concept keyword.

FIGS. 18 to 20 illustrate other examples of search windows.

With reference to FIG. 18, a subject-position/size designating window 81 is being displayed at the upper part of a search window 80. The position and size of a subject contained in an image to be found are designated using the subject-position/size designating window 81, a will be described later.

Characters reading “POSITION” are being displayed at the lower right of the subject-position/size designating window 81. A check box 82, characters reading “ABSOLUTE POSITION”, a check box 83 and characters reading “RELATIVE POSITION” are being displayed to the right of the characters “POSITION”. A check box 84 and characters reading “SIZE” are being displayed below the characters “POSITION”. A check box 85 and characters reading “KEYWORD ONLY” are being displayed below the characters “SIZE”. An ENTER button 86 and a SEARCH button 87 are being displayed at the lower right of the search window 80.

In a case where the position of a subject is designated by its absolute position (its absolute position with respect to the image), the check box 82 is checked. In a case where the position of a subject is designated by its relative position (the relative positional relationship of the subject contained in the image), the check box 83 is checked. In a case where the size of a subject is designated, the check box 84 is checked. In case of a search based solely upon a keyword (subject name or broader-concept keyword), the check box 85 is checked. If the check box 85 is checked, the check boxes 82, 83 and 84 cannot be checked.

If the check box 82 is checked and the ENTER button 86 is clicked, the search window 70 shown in FIG. 17 appears and the absolute position is input in the area 72.

If the check box 83 is checked, the subject position and size can be designated using the subject-position/size designating window 81. By dragging the mouse within the subject-position/size designating window 81, a rectangle (or another shape such as a circle if desired) is displayed. If rectangles the number of which is equivalent to the number of subjects contained in the image are displayed in the subject-position/size designating window 81, keywords can be entered in these rectangles. The positional relationship of the subjects is decided by the positional relationship among the subjects specified by the entered keywords and the rectangles.

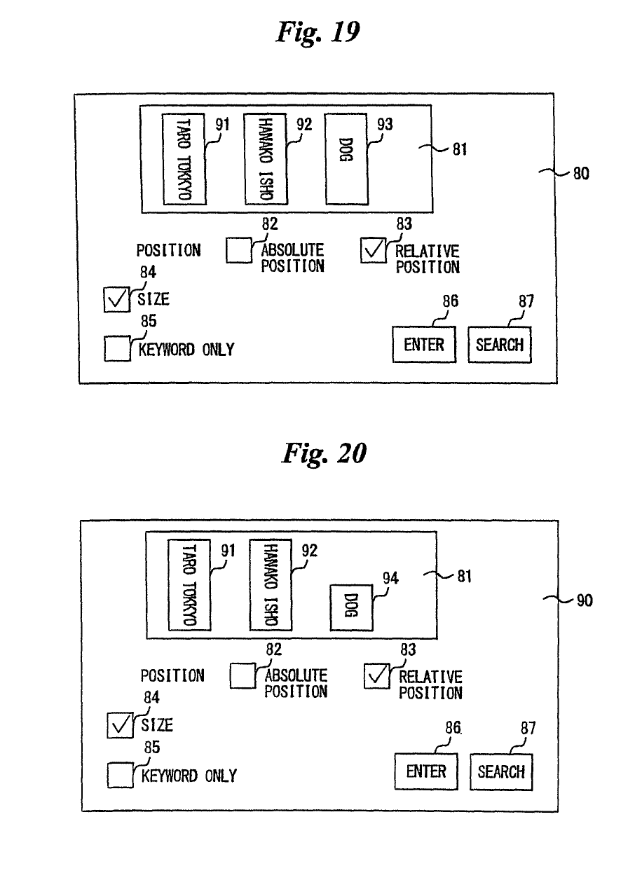

With reference to FIG. 19, rectangles 91, 92 and 93 are displayed in the subject-position/size designating window 81 in the manner described above. Keywords “Taro Tokkyo”, “Hanako Isho” and “Dog” are being displayed in the rectangles 91, 92 and 93, respectively. If the SEARCH button 87 is clicked, an image is found from the image database 12, the image being one which contains subjects having “Taro Tokkyo”, “Hanako Isho” or “Dog” as the keyword and, moreover, in which the positional relationship among these subjects matches the positional relationship of the rectangles 91 to 93 shown in FIG. 19.

If the check box 84 has been clicked, an image is found which contains subjects having sizes that correspond to the relationship between the sizes of the subjects with respect to the image and the sizes of the rectangles 91 to 93 with respect to the subject-position/size designating window 81.

By dragging one side or the vertical angle of any of the rectangles 91 to 93 being displayed in the subject-position/size designating window 81, the size of any of the rectangles 91 to 93 can be changed in the dragged direction.

FIG. 20 is an example of a search window 90 in which a rectangle 94, which is the result of changing the size of the rectangle 93, is being displayed. By changing a rectangle to the desired size, an image containing the image of the subject having the desired size can be found.

If the SEARCH button 87 is clicked, an image search can be conducted based upon subject position and size, etc., in accordance with the checking of the check boxes.

For example, assume that the image 20 shown in FIG. 4 and the images 41 to 45 shown in FIGS. 10 to 14 have been stored in the image database 12.

An example of a search regarding a case where only keywords have been input will be described as a first search method. Assume that “Taro Tokkyo”, “Hanako Isho” and “Dog” have been input as keywords. Images containing subject 21 or 51 having “Taro Tokkyo” as the subject name and subject 22 or 52 having “Hanako Isho” as the subject name, and further containing subject 24 or 54 having the entered keyword “Dog” as a broader-concept keyword are the images 20, 41, 42, 44 and 45. These images 20, 41, 42, 44 and 45 are images retrieved as the result of the search.

An example of a search regarding a case where keywords and relative positions have been designated will be described as a second search method. Assume that an image in which “Taro Tokkyo” is on the right side of “Hanako Isho” and “Dog” is on the right side of “Taro Tokkyo” is to be found. Images for which “Taro Tokkyo”, “Hanako Isho” and “Dog” have been registered as keywords are images 20, 41, 42, 44 and 45. Among these images 20, 41, 42, 44 and 45, those in which “Taro Tokkyo” is on the right side of “Hanako Isho” are images 41 and 43. Further, an image in which “Dog” is on the right side of “Taro Tokkyo” is image 41. Accordingly, image 41 is the image retrieved by the search.

An example of a search regarding a case where keywords and absolute positions have been designated will be described as a third search method. Assume that an image in which “Hanako Isho” is in an area that is 20% from the left, “Taro Tokkyo” is in an area that is 10 to 40% from the left and “Dog” is farther right than 50% is to be found. Images for which “Taro Tokkyo”, “Hanako Isho” and “Dog” have been registered as keywords are images 20, 41, 42, 44 and 45. Among these images 20, 41, 42, 44 and 45, the image that satisfies the designated-position requirements is the image 41.

An example of a search regarding a case where keywords and relative sizes have been designated will be described as a fourth search method. Assume that an image in which “Dog” is larger than “Automobile” and “Taro Tokkyo” is larger than “Hanako Isho” is to be found. Images that contain “Dog”, “Automobile”, “Taro Tokkyo” and “Hanako Isho” as subjects are images 20, 41, 42, 44 and 45. Among these images 20, 41, 42, 44 and 45, images in which “Dog” is larger than “Automobile” are images 44 and 45. Further, an image in which “Taro Tokkyo” is larger than “Hanako Isho” is image 45.

An example of a search regarding a case where keywords and relative sizes of subjects have been designated will be described as a fifth search method. Assume that an image in which “Dog” has been captured at a size that is 25% or more of the image in the vertical and horizontal directions is to be found. Images containing “Dog” are images 20, 41, 42, 44 and 45. Among these images 20, 41, 42, 44 and 45, images in which the size of “Dog” is the designated size are images 44 and 45.

As for a sixth search method, assume that images satisfying all of the second to fourth search methods are to be found. That is, assume that an image to be found is one in which “Dog” is in the right-half of the image and has a size that is 25% or more of the image in the vertical and horizontal directions, and “Hanako Isho” is on the right side of “Taro Tokkyo” and is smaller than “Taro Tokkyo”. Images containing “Dog”,

“Taro Tokkyo” and “Hanako Isho” are images 20, 41, 42, 44 and 45. In all of these images 20, 41, 42, 44 and 45, “Dog” is in the right-half of the image. Images in which the size of “Dog” is 25% or more of the image in the vertical and horizontal directions are images 44 and 45. Images in which “Hanako Isho” is on the right side of “Taro Tokkyo” also are the images 44 and 45. The image in which “Hanako Isho” is smaller than “Taro Tokkyo” is the image 45.

It will be understood from the foregoing examples that it is possible to conduct a search that can be narrowed down to give better results than would be obtained by retrieving images using keywords alone.

If an image having a designated keyword, etc., cannot be found, a conceivable method of dealing with this is as follows:

First, display the fact that the pertinent image cannot be found.

Second, display images close to the conditions designated by the user. For example, assume that image 45 did not exist in the sixth search method described above. Images that match the following conditions will be displayed: Condition 1 is that “Dog” is on the right side. Condition 2 is that the size of “Dog” is 25% of the image vertically and horizontally. Condition 3 is that the image contain “Hanako Isho” and “Taro Tokkyo”. Condition 4 is that “Hanako Isho” is on the right side of “Taro Tokkyo”. Condition 5 is that “Hanako Isho” is smaller than “Taro Tokkyo”. It may be arranged to display image 44, which fails to satisfy only Condition 5, or to display images that fail to satisfy only any of a plurality of conditions.

Third, display images, which are closed to the conditions, ranked according to predetermined conditions. Search conditions include keywords, subject positions and subject sizes. An order of priority is assigned to these search conditions. For example, a keyword is made an essential condition and subject position is assigned the next highest priority. In a case where image 45 does not exist in the fifth search method described above, images containing “Dog”, “Hanako Isho” and “Taro Tokkyo” are images 20, 41, 42, 44 and 45. Next, images satisfying the conditions that “Dog” be in the right-half and “Taro Tokkyo” be on the right side of “Hanako Isho” are images 20 and 44. The images retrieved will be the images 20 and 44.

In the foregoing embodiments, the size of a subject is indicated by the lengths thereof vertically and horizontally. However, the area of the subject may be utilized. Further, the broader concept of a subject name is represented by the type (gender, human, etc.) of the subject having this subject name. However, the broader concept may just as well be the affiliation (Section AA, Department BB, Company CC, etc.) of the subject. Further, the positional relationship is not limited to the horizontal direction and may just as well be the vertical direction. Furthermore, it may be so arranged that the size of a subject is judged based not upon whether it is larger in both the vertical and horizontal directions but only in one direction.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for appending a keyword to an image, comprising:
a keyword-target image data input device for inputting keyword-target image data for appending a keyword;
a first detecting device for detecting a predetermined subject and position of this subject from a keyword-target image represented by the keyword-target image data that has been input from said keyword-target image data input device; and
a storage control device for storing data representing name of the subject and data representing the position of the subject, which has been detected by said first detecting device, on a storage medium in correlation with the keyword-target image data as data used in searching for the keyword-target image.

2. The apparatus according to claim 1, further comprising a second detecting device for detecting the size of the subject, which has been detected by said first detecting device, in the keyword-target image;
wherein in addition to the data representing the name of the subject and the data representing the position of the subject, which has been detected by said first detecting device, said storage control device stores data representing the size detected by said second detecting device on the storage medium in correlation with the keyword-target image data as data used in searching for the keyword-target image.

3. The apparatus according to claim 1, wherein the position of a subject detected by said first detecting device is the position of an area in which the subject is present in a case where the keyword-target image has been divided into a plurality of areas.

4. The apparatus according to claim 1, wherein the position of a subject detected by said first detecting device is a position decided by an overall ratio, vertically and horizontally, with respect to the keyword-target image.

5. The apparatus according to claim 1, further comprising a third detecting device for detecting the name of a broader concept of the subject detected by said first detecting device;
wherein in addition to the data representing the name of the subject and the data representing the position of the subject, which has been detected by said first detecting device, said storage control device stores data representing the name of the broader concept detected by said third detecting device on the storage medium in correlation with the keyword-target image data as data used in searching the keyword-target image.

6. An image search apparatus comprising:
a keyword input device for inputting a keyword;
a position input device for inputting position of a subject corresponding to the keyword that has been input by said keyword input device; and
a search device for finding an image from among a number of images, wherein the image includes a subject corresponding to at least one of the keyword that has been input from said keyword input device and a broader concept of this keyword, or to at least one of the keyword that has been input from said keyword input device and a more limitative concept of this keyword, the subject being present at the position that has been input from said position input device.

7. The apparatus according to claim 6, further comprising a size designating device for designating the size of a subject, which corresponds to a keyword that has been input from said keyword input device, in an image;
wherein said search device finds an image from among a number of images, the image including a subject corresponding to the keyword that has been input from said keyword input device, the subject being present at the position that has been input from said position input device and having the size designated by said size designating device.

8. A method of controlling operation of an apparatus for appending a keyword to an image, comprising the steps of:
inputting keyword-target image data for appending a keyword;
detecting a predetermined subject and position of this subject from a keyword-target image represented by the keyword-target image data that has been input; and
storing data representing name of the detected subject and data representing the position of the detected subject on a storage medium in correlation with the keyword-target image data as data used in searching for the keyword-target image.

9. A method of controlling operation of an image search apparatus, comprising the steps of:
inputting a keyword;
inputting position of a subject corresponding to the keyword that has been input; and
finding an image from among a number of images, wherein the image includes a subject corresponding to at least one of the keyword that has been input and a broader concept of this keyword, or to at least one of the keyword that has been input and a more limitative concept of this keyword, the subject being present at the position that has been input.
